(19) United States
(12) Patent Application Publication
(10) Pub. No.: US 2026/0233840 A1
(43) Pub. Date: Aug. 13, 2026

(54) PASSIVE VIBRATION ISOLATOR

(71) Applicant: Point Blank Enterprises, Inc., Pompano Beach, FL (US)

(72) Inventor: Marvin Kent Richards, Auburndale, FL (US)

(21) Appl. No.: 19/051,318

(22) Filed: Feb. 12, 2025

(51) Int. Cl. B64D 11/06; F16F 9/20; F16F 9/512; F16F 15/02

(52) U.S. Cl. CPC B64D 11/0619; F16F 9/20; F16F 9/5126; F16F 15/022

(57) ABSTRACT

A passive vibration isolator device, including a spring and a dampening element, is connected in series with a motion gap element that allows for relative displacement between the vibration source and the passive vibration isolator device to achieve ideal passive vibration isolation without engagement of the dampening element. The dampening element of the passive vibration isolator, in one exemplary embodiment, includes a self-locking damper design. The self-locking damper is designed to automatically lock during high acceleration events to limit the amount of added seat stroke otherwise absorbed by the passive vibration isolator.

### FIELD OF THE INVENTION

The present invention relates generally to a passive vibration isolation device and, more particularly, to a passive vibration device configured to reduce whole body vibration felt by a seated occupant.

### SUMMARY OF THE INVENTION

The present invention is directed to a passive vibration isolation device (referred to as a “PVI Device”) that is designed and otherwise configured to eliminate requirements for an electronic controller, effectively reducing the cost, weight, and complexity of a seating device for rotorcraft or rotary-wing aircraft. The PVI device provides substantially little to no damping during specified design vibration isolation frequencies. It provides damping during transient events such as low-frequency inputs or external force applications. The PVI device prevents system resonance and unwanted high displacement and includes, in some embodiments, a passive self-locking damper.

Introducing a first embodiment of the invention, the present invention consists of a passive vibration isolation device for an aircraft seating system, comprising:
a damper assembly;
one or more springs in mechanical communication with the damper assembly; and
at least one gap element in communication with the damper assembly, the gap element delimiting a gap, wherein the gap is of a predetermined size,
wherein the damper assembly remains in a disengaged condition until an input force causes relative motion between the input force and an isolated mass on the seating system to exceed the gap element's gap.

In another aspect, wherein at least one gap element and the damper assembly are connected in series. The damper assembly may comprise a floating piston housed in a fluid-filled piston housing and includes a rod that engages the floating piston. In some embodiments, the rod of the damper assembly includes a contiguous distal end and is in series with the gap element. It also has an annular gap that allows fluid to flow between the floating piston and the rod. It is also contemplated that the damper assembly includes a fluid-filled cylinder in communication with a two-way valve, wherein the two-way valve comprises a flow restrictor and spring-loaded element configured to maintain the two-way valve in an open position until pilot pressure from high fluid flow acts on the flow restrictor to close the two-way valve.

In another aspect, the PVI device's one or more springs may be housed within the piston housing and retained in place by annular edges on the piston. One or more springs self-center the piston inside the piston housing, and the piston may include a pathway that allows fluid flow to pass through.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a bottom perspective view of an aircraft seating system that includes an exemplary embodiment of the passive vibration isolation device in accordance with the instant invention;

FIG. 2 presents a magnified perspective view of the aircraft seating system shown in FIG. 1 with the passive vibration isolation device;

FIG. 3 presents an exemplary schematic of a passive vibration isolation device shown in FIG. 1;

FIG. 4 presents an exemplary schematic of a passive vibration isolation device shown in FIG. 1;

FIG. 5 presents an exemplary schematic view of the hydraulic system and the self-locking damper system of the passive vibration isolation device shown in FIG. 1;

FIGS. 6 through 8 present a cross-sectional view of a self-locking damper system of the passive vibration isolation device;

FIG. 9 presents a cross-sectional view of an alternative embodiment of a self-locking damper system of the passive vibration isolation device; and

FIG. 10 presents a cross-sectional view of the exemplary passive vibration isolation device shown in FIG. 1.

Like reference numerals refer to like parts throughout the several views of the drawings.

### DETAILED DESCRIPTION

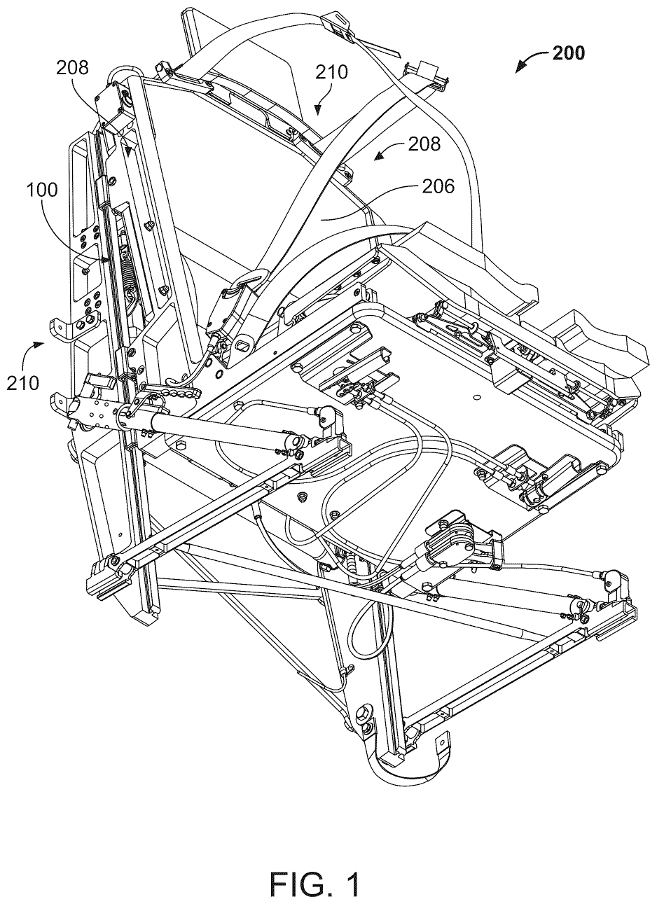

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

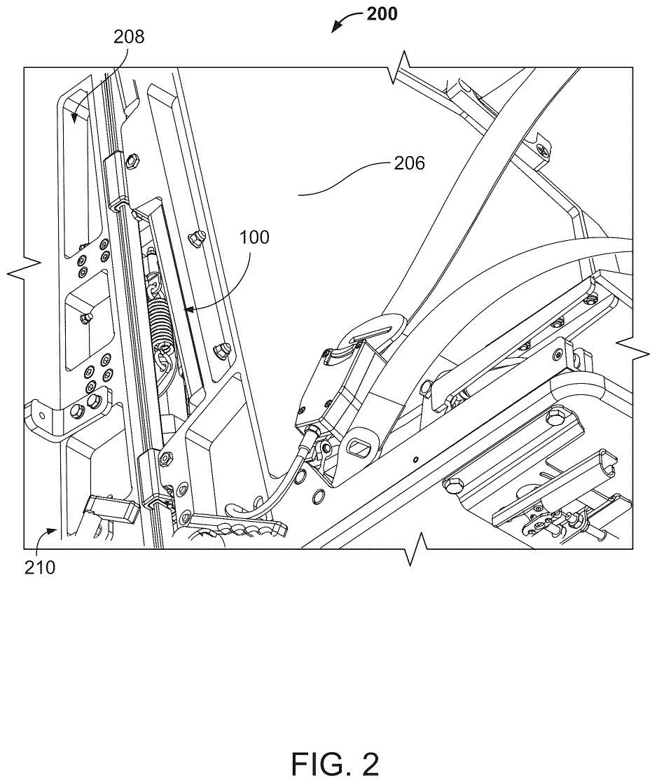

Referring initially to FIGS. 1 and 2, a passive vibration isolation device 100 (hereinafter referred to as the “PVI device”) is shown installed to a seating system 200 of an aircraft. As exemplarily shown, one or more PVI devices 100 may be placed along the vertical portion 206 of the seating device 200 proximate to the back side 210 of the upper portion 206 to provide vibration isolation in the vertical direction otherwise felt on the seated occupant. To the extent there are at least two PVI devices installed onto the seating system 200, each PVI device 100 is symmetrically placed proximate to the vertical back side ends 208 of the vertical portion 206 of the seating system 200, with each PVI device 100 being spaced apart a distance. The distance in some embodiments spans the proximate width of the backrest of the seating device. The PVI device 100 is also generally assembled onto the seating system 200 substantially perpendicular to the seat of the seating system 200 and proximate to the vertical back side ends (or frame) of the seating system 200, as best illustrated in FIG. 2.

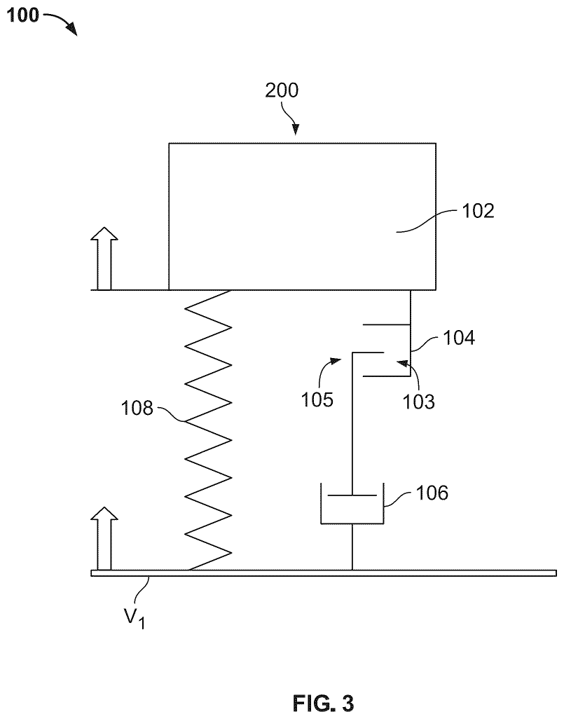

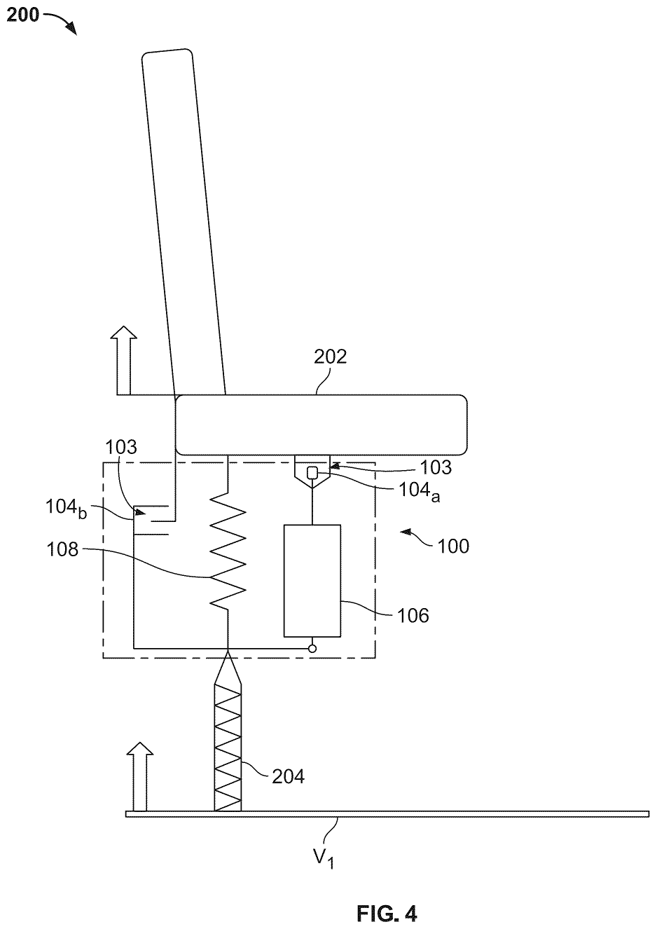

Turning now to FIGS. 3 and 4, a schematic view of the PVI device 100 installed to a seating system 200 of an aircraft configured to protect a seated occupant from high vertical acceleration events, i.e., high G-events, such as without limitation to a helicopter crash, is generally shown. The PVI device 100 in one exemplary embodiment includes a gap element 104, one or more springs 108, and a damping assembly 106. The one or more springs 108 of the PVI device 100 is generally connected between the input or vibration source V₁ and the isolated mass 102 (i.e., the seated occupant). The damping assembly 106 of the PVI device is generally mounted in series with the gap element 104, to be described further herein below, which is mountable in parallel to the support spring 108 of the PVI device 100. The gap element 104 of the PVI device 100 is designed and otherwise configured to allow relative displacement between the vibration source V₁ and the isolated mass 102 without engagement of the damping assembly or element 106. It should be readily understood that the size of the gap 104 is generally sized to be greater than the relative displacement between the input vibration V₁ and the isolated mass 102 based on an input vibration value and the desired isolation frequency range. In other words, the gap size of the gap element may differ depending on the desired isolation frequency range and estimated input vibration value. The one or more springs 108 used with the PVI device 100 may include, without limitation, a coil spring, leaf spring, diaphragm spring, gas spring, hydraulic damper, or the like. The gap element 104 of the PVI device 100 may be connected to the damping assembly 106 through any viable connection that allows controlled relative displacement within the damping assembly's load path. In some exemplary embodiments, the connection may include, without limitation, a pin in a slot, an oversized hole with a pin, a pivoting linkage, an integrated or external damper, or the like.

The PVI device 100 is designed to function under several operational scenarios. For example, when the PVI device 100 is operating under normal operational conditions, i.e., force imposed on the PVI device is within the designed input vibration frequency and amplitude range, the gap size of the gap element 104 allows relative displacement between the input and the isolated mass 102, thereby preventing force application through the damping assembly 106. Under these conditions, the PVI device, despite having a damping assembly, functions as an equivalent system that does not include a damping system to provide ideal passive vibration isolation performance.

In situations where there is a change in system mass, i.e., force imposed on the PVI device exceeds operation frequency and amplitude designs for the gap element 104, there is corresponding deflection of the support spring 108 until the force equilibrium is attained. In other words, deflection of the spring occurs until the spring force is equal to the mass weight. One such example of this occurring is when there is a change in the occupant seating on the seating system 200. In instances where the deflection is greater than the size of the gap 103 of the gap element 104 (FIG. 3), a force is applied to the damper assembly 106, causing it to deflect and allowing the relative position of the gap element 104 to move a distance or amount equal to, in some instances less than, the displacement of the springs 108. As such, the gap element 104 self-centers and the PVI device 100 returns to the “normal operation” or undamped vibration isolation mode, as described above. During transient displacement, the damping assembly 106 is designed to be partially engaged to result in reduced vibration isolation for a short period of time. Put differently, during transient displacement, the PVI device 100 behaves as a damped isolation device. The time duration for this transition is dependent upon the magnitude of the damping and the change in mass or vertical displacement exerted on the seated system 200.

The PVI device 100 is designed in such a way that an increase in frequency and magnitude of input vibration V₁ can still provide an ideal undamped passive isolation effect, as described above, so long as the relative motion between the input and the isolated mass is less than the size of the gap of the gap element 104. Conversely, any combination of input frequency and magnitude where the relative displacement of the isolated mass becomes larger than the size of the gap of the gap element 104, the PVI engages the damper assembly 106. Accordingly, the PVI device 100 can function to include damped and undamped conditions dependent upon the frequency and magnitude change inputted to the system.

With continued reference to FIGS. 3 and 4, the PVI device 100, in one exemplary embodiment, is connected in series with the seat energy absorbing assembly 204 and the seat stroking assembly 202 of the aircraft seating system 200. As exemplary shown in FIG. 4, the PVI device 100 may include at least two gap elements 104a, 104b delimiting a gap 103 configured to limit the vertical displacement of the spring 108. The gap elements 104a, 104b are sized and otherwise configured to limit the vertical displacement of the seat assembly 202 to be larger than the motion required to accommodate the deflection of the spring 108 for the designed maximum occupant weight in addition to the designed motion required for passive vibration isolation. The gap elements 104 is connected or otherwise in communication with a distal end portion 105 of the damper assembly (FIG. 3). In some exemplary embodiments, the damper assembly 106 may include a self-locking mechanism that prevents excessive vertical displacement of the PVI device 100 during high vertical acceleration events. The self-locking mechanism improves seat stroking performance by limiting the added seat stroke caused by the device's deflection in series with the energy that is being absorbed. As shown in FIG. 4, at least one gap element 104a may be in series with the damper assembly 106 to achieve the ideal passive vibration.

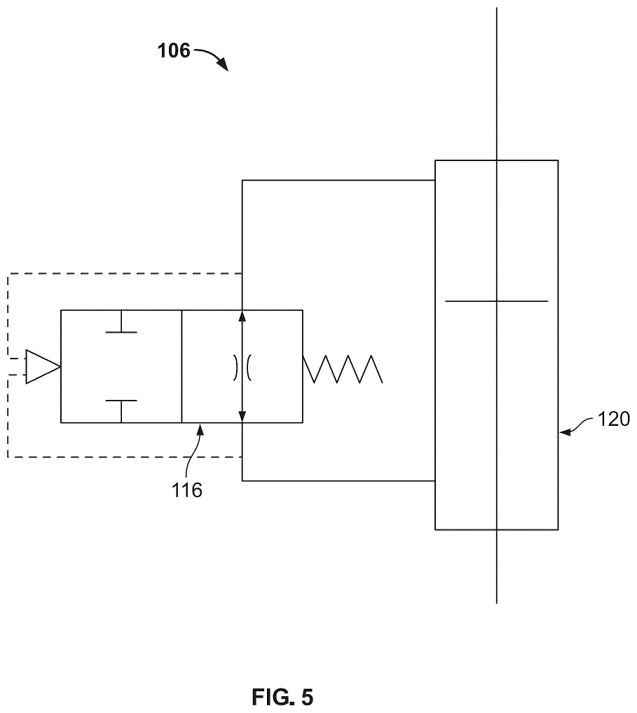

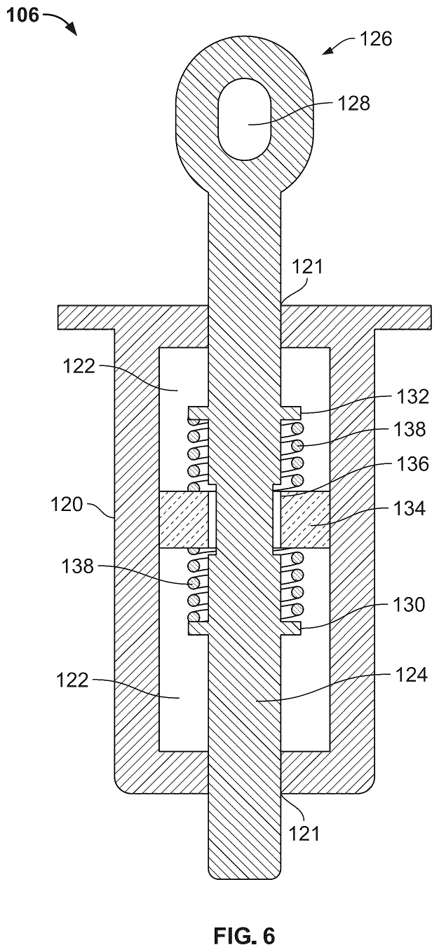

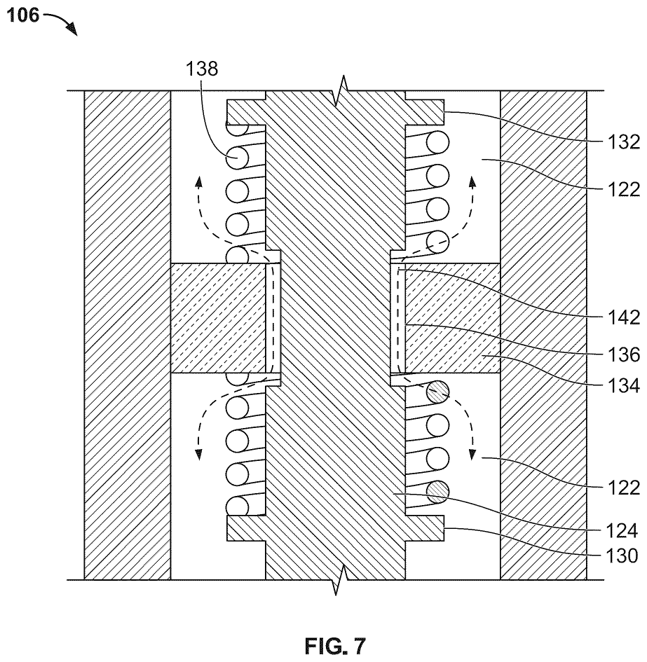

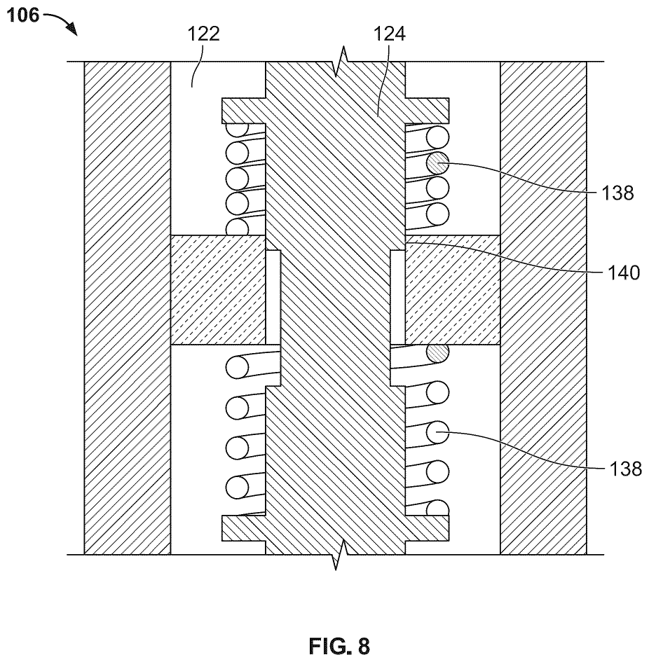

Referring now to FIGS. 5 through 8, a hydraulic schematic of a self-locking damper assembly 106 of the PVI device is generally shown. The damper assembly 106, in one exemplary embodiment, may include a fluid-filled cylinder 120 in communication with a two-way on/off valve 116. The valve 116, without limitation, is spring loaded and normally in an open position with a flow restrictor that will close from pilot pressure from high fluid flow. Specifically referring to FIGS. 6 through 8, the damper assembly 106 generally comprises a cylinder housing 120, a cylinder rod 124 that includes a lower annular edge 130, an upper annular edge 132, a floating annular piston 134, one or more piston centering springs 138, and a working hydraulic fluid 122 filling the inside of the hydraulic cylinder 120. In some exemplary embodiments, the gap element 104 may be integrated or otherwise connected to the damper assembly 106. As exemplary shown in FIG. 6, the distal end 126 of the rod 124 of the damper assembly may include a gap element 128 delimiting a gap. With continued reference to FIG. 6, rod 124 is of sufficient size to pass through openings 121 at the bottom and top end of cylinder 120. Despite rod 124 traversing the piston housing 120, the total fluid volume 122 inside housing 120 does not change during the displacement of the rod 124 and piston 134 assembly, as the housing is sealed. Although it is contemplated that a traditional single-cylinder rod could be used with the PVI device, changes in internal fluid volume in traditional single-cylinder rod devices are accommodated with a gas-filled partition.

Specifically referring to FIGS. 6 through 8, rod 124 of the damper assembly 106, in some exemplary embodiments, includes a necked down portion or an annular gap 124, which provides a restricted fluid flow path 142 through an annular gap 136 in the piston 134. The springs 138 self-center the floating piston 134 at the necked down portion 124 to allow damper motion during normal operation. As described above, the spring force must be greater than the total force of the seat stroking weight plus the maximum occupant weight to allow damper displacement to center the gap element 128 for passive vibration isolation. During a high vertical acceleration event, such as a helicopter crash, the pressure differential across the piston 134 will compress and bottom out the spring 138, blocking fluid flow through the annular piston gap 136. In this state, hydraulic lock will prevent damper displacement until the applied force causing the hydraulic lock is less than the spring force of the springs, which will allow re-opening of the pathway 142 for fluid to pass through the piston gap 136. In the foregoing high vertical acceleration event, the total vibration isolator displacement is limited to the size of the gap element's displacement plus the cylinder rod's displacement that is required to bottom out the spring 138 centering the piston. The self-locking feature of the damper assembly 106 achieves the critical objective of minimizing seat displacement, thereby preventing excessive seat stroke during a high vertical acceleration event.

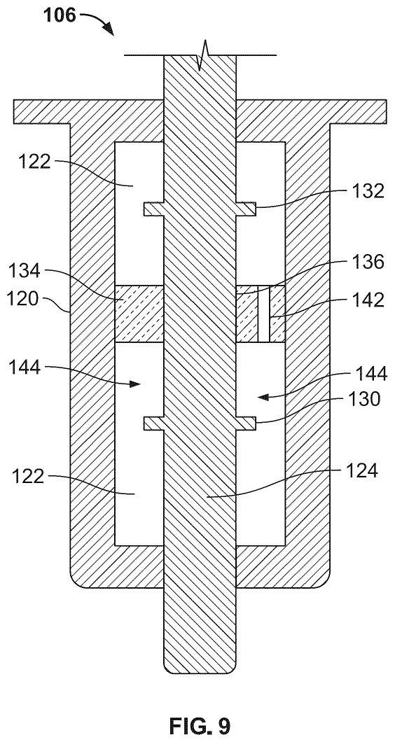

In one alternative embodiment, as illustrated in FIG. 9, the damper assembly 104 can include a gap element 144, delimiting a gap within the internal portion of cylinder 120 of the PVI device 100. In this exemplary configuration, the piston 134 is free-floating along the rod 124 and the housing's axis. The rod 124 includes stops or annular edges 130,132 that limit or otherwise confine the piston's movement. This generally delimits the size of the gap of the gap element 144 within the housing 120 of the damper assembly 106. The piston 134 also includes a restricted fluid flow pathway 142 to provide the desired damping force when the rod's motion is greater than the gap of the gap element 144. In an alternative embodiment, the restricted pathway is achieved by increasing the size of the gap between the piston and the rod or the housing. Accordingly, there are alternative configurations that can be employed to provide flow restrictions within the housing of the damper assembly without departing from the scope of the invention.

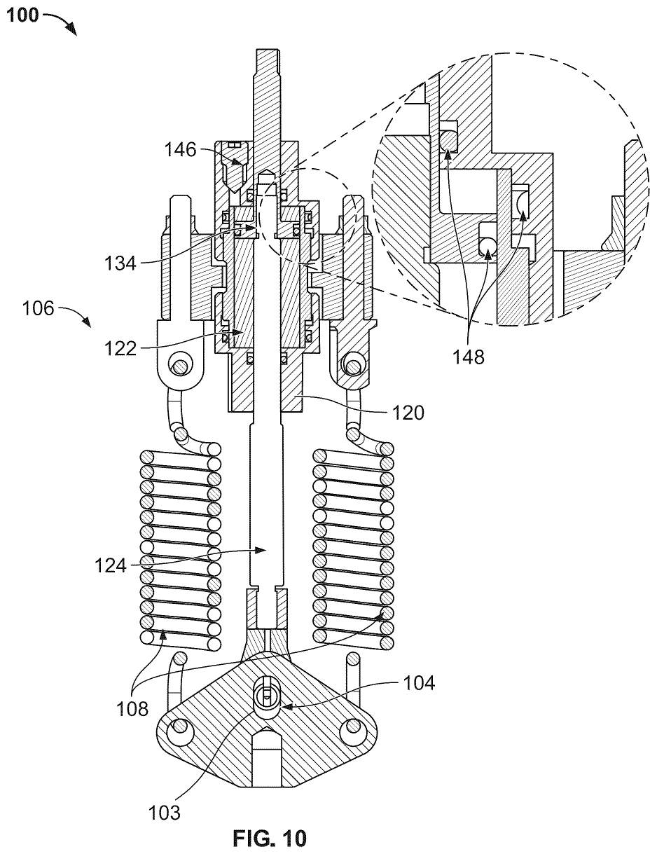

With reference to FIGS. 1 and 10, a cross-sectional view of the PVI device 100 attachable to an aircraft seating system 200 is shown. The PVI device 100 may comprise the foregoing elements, including one or more springs 108, one or more gap elements 104, and one or more damper assembly 106 comprising a rod 124 extending through open ends of a housing 120 that includes a piston 134. The housing 120 of the damper assembly 106 may include a fill/bleeder port 146 for filling or bleeding the housing of hydraulic fluid 122. The damper assembly 106 may also include one or more sealing elements 148, such as O-rings, to prevent fluid volume inside of the housing from escaping. As described above, the gap element 104 includes a gap of a determined size. The size of the gap is configured to determine whether the damper assembly engages or remains disengaged.

In summary, a pair of PVI devices symmetrically may be placed on a seating device of an aircraft to provide vibration isolation to the occupant seated in the seating device. In some embodiments, the PVI device may be placed proximate to the seatback of the seating system. Alternatively, the PVI device may be placed as the bottom of the seating system below where the occupant sits. The placement of the PVI device described herein is exemplary and should not be construed as limiting. The damper assembly of the PVI device is designed and otherwise configured to act as a stiffening member in high G events. A high G event is understood to be a high acceleration event that involves a large force, such as high G-force or acceleration. During low G events, however, the damper assembly of the PVI device defers to the springs to function as the vibration isolators when forces in the vertical direction are exposed to the seated occupant. In situations where there are low-frequency vibrations, the input gap of the damper assembly of the PVI device is designed and configured to bottom out, which engages the damping element to reduce resonant motion otherwise felt by the seated occupant on the aircraft seating device.

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

What is claimed is:

1. A passive vibration isolation device for an aircraft seating system, comprising:
a damper assembly;
one or more springs in mechanical communication with the damper assembly; and
at least one gap element in communication with the damper assembly, the gap element delimiting a gap of a predetermined size,
wherein the damper assembly remains in a disengaged condition until an input force causes relative motion between the input force and an isolated mass on the seating system to exceed the gap element's predetermined gap size.

2. The device of claim 1, wherein the at least one gap element and the damper assembly are connected in series.

3. The device of claim 1, wherein the damper assembly comprises a floating piston housed in a fluid-filled piston housing and includes a rod that engages the floating piston.

4. The device of claim 3, wherein the rod includes a distal end contiguous and in series with the gap element.

5. The device of claim 3, wherein the rod includes an annular gap about a portion of the rod that allows fluid to flow between the floating piston and the rod.

6. The device of claim 1, wherein the one or more springs are housed within the piston housing and retained in place by annular edges on the piston.

7. The device of claim 3, wherein the one or more springs self-center the piston inside of the piston housing.

8. The device of claim 3, wherein the floating piston includes a pathway for allowing fluid flow to pass through.

9. The device of claim 3, wherein the rod includes a pair of annular stops distanced apart to provide a restricted space for the floating piston to move.

10. The device of claim 1, wherein the damper assembly includes a fluid-filled cylinder in communication with a two-way valve.

11. The device of claim 10, wherein the two-way valve comprises a flow restrictor and spring-loaded element configured to maintain the two-way valve in an open position until pilot pressure from high fluid flow acts on the flow restrictor to close the two-way valve.

12. An aircraft seating system including a passive vibration isolation device, comprising:
An aircraft seating system; and
One or more passive vibration isolation devices assembled to the aircraft seating system, the passive vibration isolation device, comprising,
a damper assembly;
one or more springs in mechanical communication with the damper assembly; and
at least one gap element in communication with the damper assembly, the gap element including a gap size,
wherein the damper assembly remains in a disengaged condition until an input force causes relative motion between the input force and an isolated mass on the seating system to exceed the gap element's gap size.

13. The device of claim 12, wherein the at least one gap element and the damper assembly are connected in series.

14. The device of claim 12, wherein the damper assembly comprises a floating piston housed in a fluid-filled piston housing and includes a rod that engages the floating piston.

15. The system of claim 14, wherein the damper assembly includes a self-locking feature configured to activate during a high vertical acceleration event as a pressure differential exerted across the piston compresses and bottoms out the one or more springs to block fluid flow inside the piston housing.

16. The device of claim 12, wherein the one or more springs are housed within the piston housing and retained in place by annular edges on the piston.

17. The device of claim 12, wherein the one or more springs self-center a piston inside of the piston housing.

18. A method of damping vibration in a seating structure, comprising the steps of:
attaching at least one passive vibration isolation device to a seating system, the passive vibration isolation device comprising,
a damper assembly;
one or more springs in mechanical communication with the damper assembly; and
at least one gap element in communication with the damper assembly, the gap element including a gap size,
wherein the damper assembly remains in a disengaged condition until an input force causes relative motion between the input force and an isolated mass on the seating system to exceed the gap element's gap size.

19. The method of claim 18, wherein the damper assembly comprises a floating piston housed in a fluid-filled piston housing and includes a rod that engages the floating piston.

20. The method of claim 19, wherein the damper assembly includes a self-locking feature configured to activate during a high vertical acceleration event as a pressure differential exerted across the piston compresses and bottoms out the one or more springs to block fluid flow inside the piston housing.
